(19) United States
(12) Patent Application Publication
(10) Pub. No.: US 2024/0001278 A1
(43) Pub. Date: Jan. 4, 2024

(54) CENTRAL CONTROLLER FOR COMPLETELY CLEANING INDOOR AIR POLLUTION

(71) Applicant: Microjet Technology Co., Ltd., Hsinchu (TW)

(72) Inventors: Hao-Jan Mou, Hsinchu (TW); Chin-Chuan WU, Hsinchu (TW); Yung-Lung HAN, Hsinchu (TW); Chi-Feng HUANG, Hsinchu (TW)

(73) Assignee: Microjet Technology Co., Ltd., Hsinchu (TW)

(21) Appl. No.: 17/866,811

(22) Filed: Jul. 18, 2022

(30) Foreign Application Priority Data
Jun. 30, 2022 (TW) 111124545

(51) Int. Cl. B01D 46/46; B01D 46/42; B01D 46/44; B01D 46/56; B01D 46/10; B01D 46/00; B01D 53/62; B01D 53/66; B01D 53/50; B01D 53/56; B01D 53/64; B01D 53/72; B01D 53/85; B01D 53/00; B01D 53/86; B01D 53/34

(52) U.S. Cl. CPC B01D 46/46; B01D 46/429; B01D 46/442; B01D 46/56; B01D 46/10; B01D 46/0036; B01D 46/0028; B01D 53/62; B01D 53/66; B01D 53/508; B01D 53/565; B01D 53/64; B01D 53/72; B01D 53/85; B01D 53/007; B01D 53/86; B01D 53/346; B01D 53/8696; B01D 2273/30; B01D 2279/65; B01D 2279/50; B01D 2253/102; B01D 2253/108; B01D 2257/502; B01D 2257/504; B01D 2255/802; B01D 2259/804; B01D 2259/818; G06Q 50/265

(57) ABSTRACT

A central controller for completely cleaning indoor air pollution is disclosed. The central controller is disposed in an indoor space to detect air pollution and output air pollution data. Intelligence operations are implemented in accordance with the air pollution data by the central controller to determine a location of the air pollution, and a controlling instruction is intelligently and selectively issued through a wireless communication transmission to enable a plurality of physical filtration devices or a plurality of chemical filtration devices. Each physical filtration device or each chemical filtration device includes a fan and a filter element. The fan is driven upon receiving the controlling instruction to generate an airflow convection in a direction. The air pollution is removed through the filter element, so that the air pollution in the indoor space is completely cleaned to form a clean and safe breathing air state.

### FIELD OF THE INVENTION

The present disclosure relates to a central controller for detecting and completely cleaning air pollution, and more particularly to a central controller for completely cleaning indoor air pollution.

### BACKGROUND OF THE INVENTION

In recent years, people pay more and more attention to the air quality around their living environment. Particulate matter (PM), such as PM₁, PM_{2.5} and PM₁₀, carbon monoxide, carbon dioxide, total volatile organic compounds (TVOC), formaldehyde and even suspended particles, aerosols, bacteria and viruses contained in the air and exposed in the environment might affect human health, and even endanger people's life.

However, it is not easy to control the indoor air quality. In addition to the air quality of the outdoor space, the air environmental conditions and pollution sources, especially the dusts originated from poor air circulation in the indoor space, are the major factors that affect indoor air quality. In order to quickly improve the indoor air quality, several devices, such as air conditioners or air purifiers are utilized to achieve the purpose of improving the indoor air quality.

Therefore, in order to intelligently and quickly detect the location of the indoor air pollution, effectively remove the indoor air pollution to form a clean and safe breathing air state, instantly monitor the indoor air quality, and quickly purify the indoor air when the indoor air quality is poor, it becomes important to find a solution to intelligently generate an airflow convection in the indoor space, quickly detect and locate the air pollution, and effectively control plural physical and/or chemical filtration devices to implement an intelligent airflow convection to accelerate airflow in the desired direction(s), and filter and remove air pollution sources in the indoor space by locating the air pollution, draining the air pollution and completely cleaning the air pollution in the indoor space so as to achieve a clean and safe breathing air state.

### SUMMARY OF THE INVENTION

One object of the present disclosure is to provide a central controller for completely cleaning indoor air pollution. The central controller is disposed in an indoor space to detect air pollution in the indoor space and generate air pollution data, and to process the air pollution data using wireless communication. Then, the characteristic, the concentration and the location of the air pollution in the indoor space are intelligently determined, and the fan is intelligently driven to generate a directional air convection. Through the physical or chemical filtration elements, the air pollution in the indoor space is removed, so that the indoor air quality is promoted to form a clean and safe breathing air state in the indoor space.

In accordance with an aspect of the present disclosure, a central controller for completely cleaning indoor air pollution is provided. The central controller is disposed in an indoor space to detect air pollution and output air pollution data, wherein intelligence operations are implemented in accordance with the air pollution data by the central controller to determine a location of the air pollution, and a controlling instruction is intelligently and selectively issued through a wireless communication transmission to enable a plurality of physical filtration devices or a plurality of chemical filtration devices, wherein each of the physical filtration devices or the chemical filtration devices includes at least one fan and at least one filter element, wherein the fan is driven upon receiving the controlling instruction, so as to generate an airflow convection in a direction, wherein the air pollution is removed through the filter element, so that the air pollution in the indoor space is completely cleaned to form a clean and safe breathing air state.

### BRIEF DESCRIPTION OF THE DRAWINGS

The above contents of the present disclosure will become more readily apparent to those ordinarily skilled in the art after reviewing the following detailed description and accompanying drawings, in which:

FIG. 1A is a schematic view illustrating a central controller set in a filtration device for completely cleaning indoor air pollution according to an embodiment of the present disclosure;

FIG. 1B is a schematic view illustrating the filter element of the central controller for completely cleaning indoor air pollution according to the embodiment of the present disclosure;

FIG. 2 is a schematic view illustrating the central controller implemented in an indoor space for completely cleaning indoor air pollution according to the embodiment of the present disclosure;

FIG. 3 is a schematic perspective view illustrating the gas detection device of the central controller for completely cleaning indoor air pollution according to the embodiment of the present disclosure;

FIG. 4A is a schematic perspective view (1) illustrating the gas detection main part of the central controller for completely cleaning indoor air pollution according to the embodiment of the present disclosure;

FIG. 4B is a schematic perspective view (2) illustrating the gas detection main part of the central controller for completely cleaning indoor air pollution according to the embodiment of the present disclosure;

FIG. 4C is an exploded view illustrating the gas detection main part of the central controller for completely cleaning indoor air pollution according to the embodiment of the present disclosure;

FIG. 5A is a schematic perspective view (1) illustrating the base of the central controller for completely cleaning indoor air pollution according to the embodiment of the present disclosure;

FIG. 5B is a schematic perspective view (2) illustrating the base of the central controller for completely cleaning indoor air pollution according to the embodiment of the present disclosure;

FIG. 6 is a schematic view (3) illustrating the base of the central controller for completely cleaning indoor air pollution according to the embodiment of the present disclosure;

FIG. 7A is a schematic exploded view illustrating the combination of the piezoelectric actuator and the base of the central controller for completely cleaning indoor air pollution according to the embodiment of the present disclosure;

FIG. 7B is a schematic perspective view illustrating the combination of the piezoelectric actuator and the base of the central controller for completely cleaning indoor air pollution according to the embodiment of the present disclosure;

FIG. 8A is a schematic exploded view (1) illustrating the piezoelectric actuator of the central controller for completely cleaning indoor air pollution according to the embodiment of the present disclosure;

FIG. 8B is a schematic exploded view (2) illustrating the piezoelectric actuator of the central controller for completely cleaning indoor air pollution according to the embodiment of the present disclosure;

FIG. 9A is a schematic cross-sectional view (1) illustrating an action of the piezoelectric actuator of the central controller for completely cleaning indoor air pollution according to the embodiment of the present disclosure;

FIG. 9B is a schematic cross-sectional view (2) illustrating of the piezoelectric actuator of the central controller for completely cleaning indoor air pollution according to the embodiment of the present disclosure;

FIG. 9C is a schematic cross-sectional view (3) illustrating an action of the piezoelectric actuator of the central controller for completely cleaning indoor air pollution according to the embodiment of the present disclosure;

FIG. 10A is a schematic cross-sectional view (1) illustrating the gas detection main part of the central controller for completely cleaning indoor air pollution according to the embodiment of the present disclosure;

FIG. 10B is a schematic cross-sectional view (2) illustrating the gas detection main part of the central controller for completely cleaning indoor air pollution according to the embodiment of the present disclosure; and

FIG. 10C is a schematic cross-sectional view (3) illustrating the gas detection main part of the central controller for completely cleaning indoor air pollution according to the embodiment of the present disclosure; and

FIG. 11 is a block diagram showing the signal transmission of the gas detection device of the central controller for completely cleaning indoor air pollution according to the embodiment of the present disclosure.

### DETAILED DESCRIPTION OF THE PREFERRED EMBODIMENT

The present disclosure will now be described more specifically with reference to the following embodiments. It is to be noted that the following descriptions of preferred embodiments of this invention are presented herein for purpose of illustration and description only. It is not intended to be exhaustive or to be limited to the precise form disclosed.

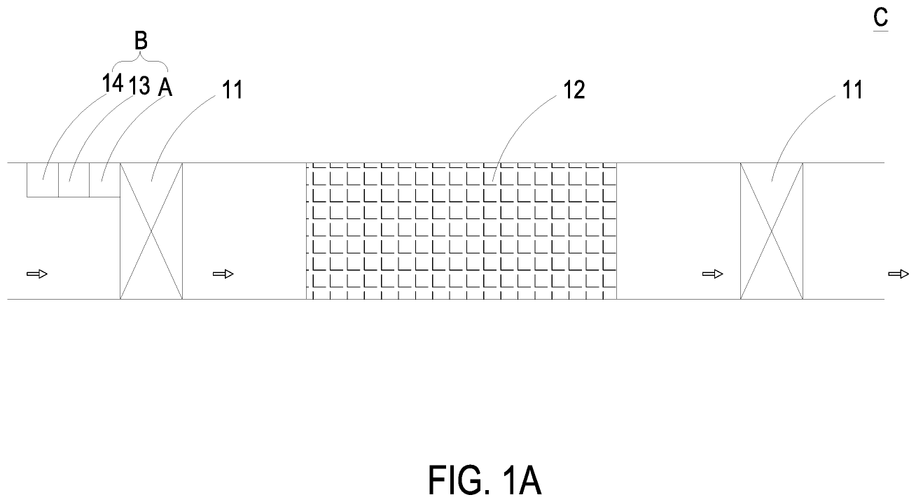

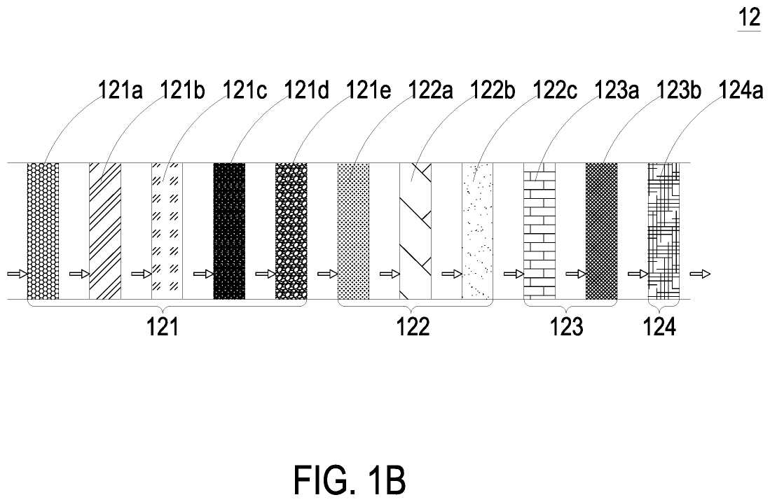

Referring to FIG. 1A, the present disclosure provides a central controller B for completely cleaning indoor air pollution. In the embodiment, the central controller B is disposed in an indoor space to detect air pollution and output air pollution data. Moreover, intelligence operations are implemented in accordance with the air pollution data by the central controller B to determine a location of the air pollution, and a controlling instruction is intelligently and selectively issued through a wireless communication transmission to enable a plurality of physical filtration devices C or a plurality of chemical filtration devices C. In the embodiment, each of the physical filtration device C or the chemical filtration device C includes at least one fan 11 and at least one filter element 12, wherein the fan 11 is driven upon receiving the controlling instruction, so as to generate an airflow convection in a direction. The air pollution is removed through the filter element 12, so that the air pollution in the indoor space is completely cleaned to form a clean and safe breathing air state.

Notably, in the embodiment, the air pollution is at least one selected from the group consisting of particulate matter, carbon monoxide, carbon dioxide, ozone, sulfur dioxide, nitrogen dioxide, lead, total volatile organic compounds (TVOC), formaldehyde, bacteria, fungi, virus and a combination thereof.

In the embodiment, the central controller B includes a central processing unit 13, a communication interface 14 and a gas detection device A. The gas detection device A detects the air pollution, provides the air pollution data and outputs the air pollution data to the central processing unit 13. The central processing unit 13 implements the intelligence operations in accordance with the air pollution data to determine the location of the air pollution, and intelligently and selectively issues the controlling instruction through the communication interface 14 to the plurality of the physical filtration device C or the chemical filtration device C.

Notably, the communication interface 14 is connected through a wired communication transmission or a wireless communication transmission. Preferably but not exclusively, the wireless communication transmission is one selected from the group consisting of a Wi-Fi communication transmission, a Bluetooth communication transmission, a radio frequency identification communication transmission and a near field communication (NFC) transmission.

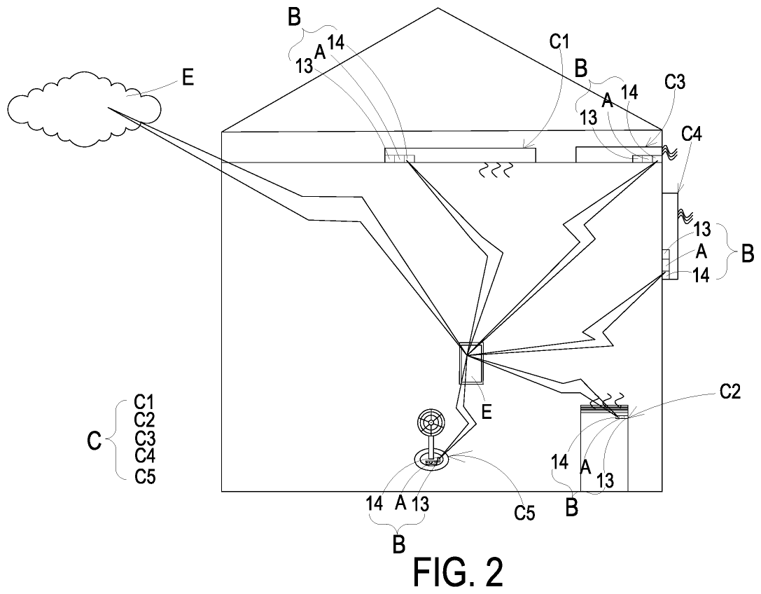

Please refer to FIG. 2. In the embodiment, the central processing unit 13 implements the intelligence operations through a connection of a cloud device E, so that artificial intelligence operations and big data comparison are implemented through the cloud device E to determine the location of the air pollution in the indoor space. The controlling instruction is intelligently and selectively issued through the communication interface 14 to the plurality of the physical filtration device C or the plurality of chemical filtration device C.

In an embodiment, the central controller B may be integrated and installed in other physical filtration devices C or chemical filtration devices C including the fan 11 and the filter element 12. Preferably but not exclusively, the physical filtration device C or the chemical filtration device C is a fresh air fan C1, a purifier C2, an exhaust fan C3, a range hood C4 or an electric fan C5. In the embodiment, the central controller B is installed on the filter device C as an example for illustration. The central controller B is installed on the filter device C, and the air pollution data is detected by the gas detection device A of the central controller B. The intelligence operations are implemented through the central processing unit 13. The artificial intelligence operations and big data comparison are implemented through the connection of the cloud device E, so as to determine the location of the air pollution in the indoor space. Moreover, the controlling instruction is intelligently and selectively issued through the communication interface 14 to the plurality of the physical filtration device C or the plurality of chemical filtration device C.

In addition, notably, the gas detection device A is disposed in the central controller B to detect the characteristic and the concentration of the air pollution. The gas detection device A is used for detecting and outputting the air pollution data, and implementing the intelligence operations through the central processing unit 13. The air pollution data detected by the gas detection devices A of the plurality of central controller B (disposed on different filtration device C) in the indoor space are received and compared through the connection of the cloud device E. In that, the artificial intelligence operations and big data comparison are implemented through the cloud device E to determine the location of the air pollution in the indoor space. The controlling instruction is intelligently and selectively issued and transmitted through the wireless communication transmission to drive the plurality of physical filtration devices C or the plurality of chemical filtration device C. That is, the air pollution data detected and provided by each gas detection device A are compared to determine the value of the air pollution data through the intelligence operations, so that the location of the air pollution is determined, and the controlling instruction is transmitted through the wireless communication transmission to drive the plurality of physical filtration devices C or the plurality of chemical filtration device C.

Notably, each of the physical filtration device C or the chemical filtration device C includes at least one fan 11 and at least one filter element 12. As shown in FIG. 1A, the fan 11 has the function of intaking and exhausting gas in both directions. In an airflow path (the direction shown by the arrow), the fan 11 is disposed at the front side of the filter element 12, or the fan 11 is disposed at the rear side of the filter element 12. As shown in FIG. 1A, the fans 11 are arranged at the front and rear sides of the filter element 12. Certainly, in other embodiments, the arrangement of the fans 11 is designed and adjustable according to the practical requirements.

Notably, the central processing unit 13 of the central controller B intelligently and selectively issues the controlling instruction through the communication interface 14 to enable a part of the plurality of physical filtration devices C or the plurality of chemical filtration devices C adjacent to the location of the air pollution first, and then intelligently and selectively issues the controlling instruction through the communication interface 14 to enable the rest of the plurality of physical filtration devices C or the plurality of chemical filtration devices C, so as to generate the airflow convection, whereby the flow of the air pollution is accelerated to drain through the airflow convection toward the plurality of physical filtration device C or the plurality of chemical filtration devices C adjacent to the location of the air pollution for filtering and cleaning the air pollution. Through the filter element 12, the air pollution in the indoor space is filtered and completely cleaned to form a clean and safe breathing air state. That is, while the plurality of gas detection devices A are connected through the cloud device E for outputting the detected air pollution data and implementing the artificial intelligence operations and big data comparison, a part of the physical filtration devices C or the chemical filtration devices C adjacent to the location of the air pollution receive the controlling instruction first, so as to be enabled for operation, and an airflow is generated first. Then, the controlling instruction is intelligently and selectively issued to enable the rest of the physical filtration devices B or the chemical filtration devices B in accordance with the position farther from the location of the air pollution for operation, so that the airflow is guided toward a direction. Whereby the flow of the air pollution is accelerated to drain by the airflow toward the filter elements 12 of the physical filtration devices C or the chemical filtration devices C adjacent to the location of the air pollution for filtering and completely cleaning, and the effects of filtering and completely cleaning the air pollution in the indoor space are achieved to form a clean and safe breathing air state.

Notably, what the air pollution is “completely cleaned” or “completely clean” means that the air pollution is filtered and cleaned to reach a safety detection value. Preferably but not exclusively, in some embodiments, the safety detection value is zero to form a clean and safe breathing air state. Preferably but not exclusively, the safety detection value may also include at least one selected from the group consisting of a concentration of PM2.5 which is less than 35 μg/m³, a concentration of carbon dioxide which is less than 1000 ppm, a concentration of total volatile organic compounds which is less than 0.56 ppm, a concentration of formaldehyde which is less than 0.08 ppm, a colony-forming unit of bacteria which is less than 1500 CFU/m³, a colony-forming unit of fungi which is less than 1000 CFU/m³, a concentration of sulfur dioxide which is less than 0.075 ppm, a concentration of nitrogen dioxide which is less than ppm, a concentration of carbon monoxide which is less than 9 ppm, a concentration of ozone which is less than 0.06 ppm, and a concentration of lead which is less than 0.15 μg/m³.

Please refer to FIG. 1B. In the embodiment, the filter element 12 of the physical filtration device is a blocking and absorbing filter screen 124 to form a physical removal device. Preferably but not exclusively, the filter screen 124 is a high efficiency particulate air (HEPA) filter screen 124a, which is configured to absorb the chemical smoke, the bacteria, the dust particles and the pollen contained in the air pollution, so that the air pollution introduced into the filter element 12 is filtered and purified to achieve the effect of filtering and purification. In the embodiment, the filter element 12 of the chemical filtration device is coated with a decomposition layer 121 to form a chemical removal device. Preferably but not exclusively, the decomposition layer 121 is an activated carbon 121a, which is configured to remove the organic and inorganic substances in the air pollution and remove the colored and odorous substances. Preferably but not exclusively, the decomposition layer 121 is a cleansing factor containing chlorine dioxide layer 121b, which is configured to inhibit viruses, bacteria, fungi, influenza A, influenza B, enterovirus and norovirus in the air pollution introduced into the filter element 12, and the inhibition ratio can reach 99%, thereby reducing the cross-infection of viruses. Preferably but not exclusively, the decomposition layer 121 is an herbal protective layer 121c, which is configured to resist allergy effectively and destroy a surface protein of influenza virus (H1N1) passing therethrough. Preferably but not exclusively, the decomposition layer 121 is a silver ion 121d, which is configured to inhibit viruses, bacteria and fungi contained in the air pollution. Preferably but not exclusively, the decomposition layer 121 is a zeolite 121e, which is configured to remove ammonia nitrogen, heavy metals, organic pollutants, Escherichia coli, phenol, chloroform and anionic surfactants. In an embodiment, the filter element 12 of the chemical filtration device B is combined with a light irradiation element 122 to form a chemical removal device. Preferably but not exclusively, the light irradiation element 122 is a photo-catalyst unit including a photo catalyst 122a and an ultraviolet lamp 122b. When the photo catalyst 122a is irradiated by the ultraviolet lamp 122b, the light energy is converted into the chemical energy to decompose harmful substances contained in the air pollution and disinfect bacteria contained in the air pollution, so as to achieve the effects of filtering and purifying. Preferably but not exclusively, the light irradiation element 122 is a photo-plasma unit including a nanometer irradiation tube 122c. When the air pollution is irradiated by the nanometer irradiation tube 122c, oxygen molecules and water molecules contained in the air pollution are decomposed into high oxidizing photo-plasma, and generates an ion flow capable of destroying organic molecules. In that, volatile formaldehyde, volatile toluene and volatile organic compounds (VOC) contained in the air pollution are decomposed into water and carbon dioxide, so as to achieve the effects of filtering and purifying. In an embodiment, the filter element 12 of the chemical filtration device is combined with a decomposition unit 123 to form a chemical removal device. Preferably but not exclusively, the decomposition unit 123 is a negative ion unit 123a. It makes the suspended particles contained in the air pollution to carry with positive charge and adhered to a dust collecting plate carry with negative charges, so as to achieve the effects of filtering and purifying the air pollution introduced. Preferably but not exclusively, the decomposition unit 123 is a plasma ion unit 123b. Through the plasma ions, the oxygen molecules and the water molecules contained in the air pollution are decomposed into positive hydrogen ions (RP) and negative oxygen ions (O₂⁻), and the substances attached with water around the ions are adhered on the surface of viruses and bacteria and converted into OH radicals with extremely strong oxidizing power, thereby removing hydrogen (H) from the protein on the surface of viruses and bacteria, and thus decomposing (oxidizing) the protein, so as to filter the introduced air pollution and achieve the effects of filtering and purifying.

In order to understand the implementation method of the present disclosure, the structure of the gas detection device A of the central controller B is described in detail as follows.

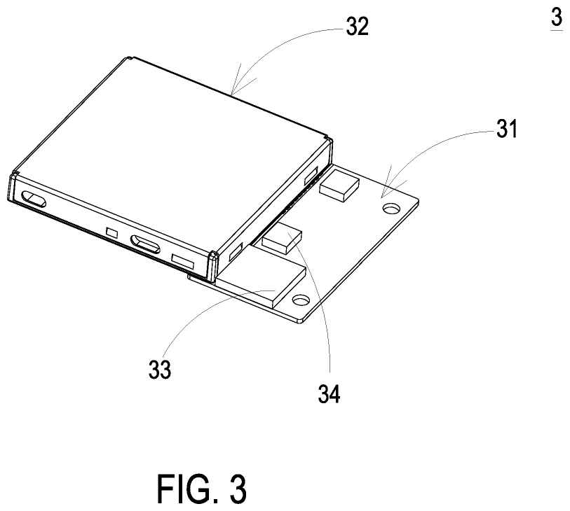

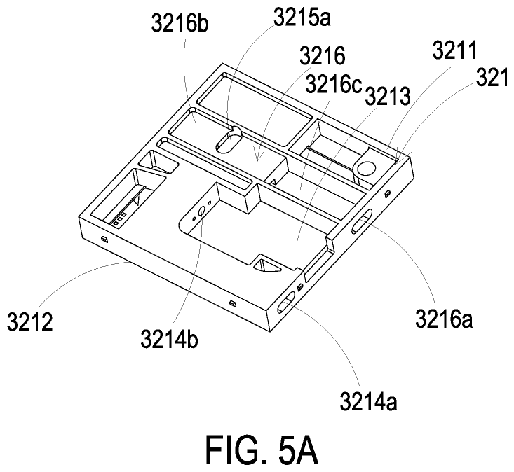

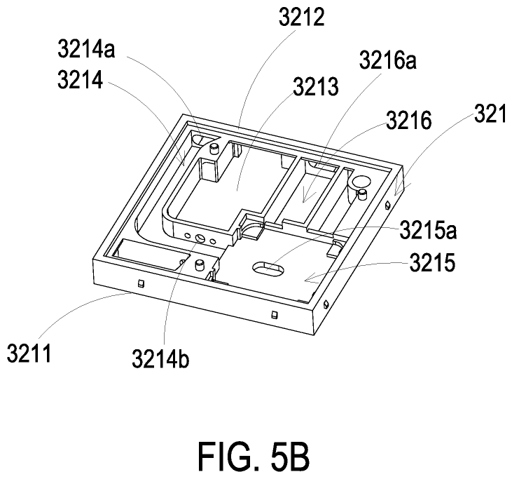

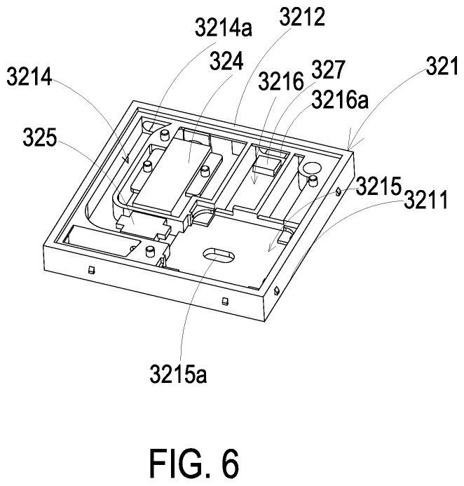

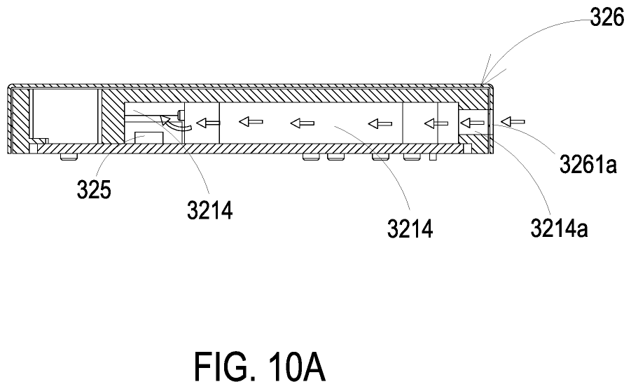

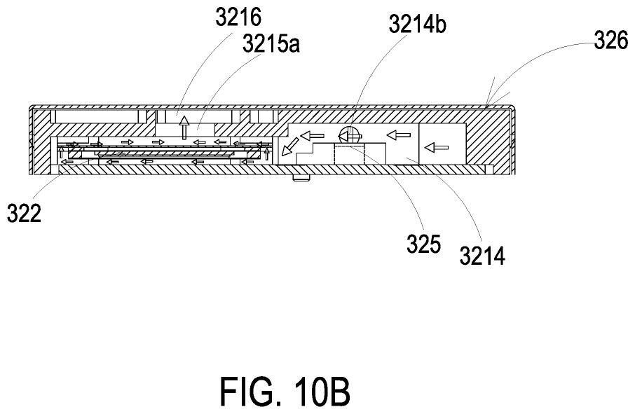

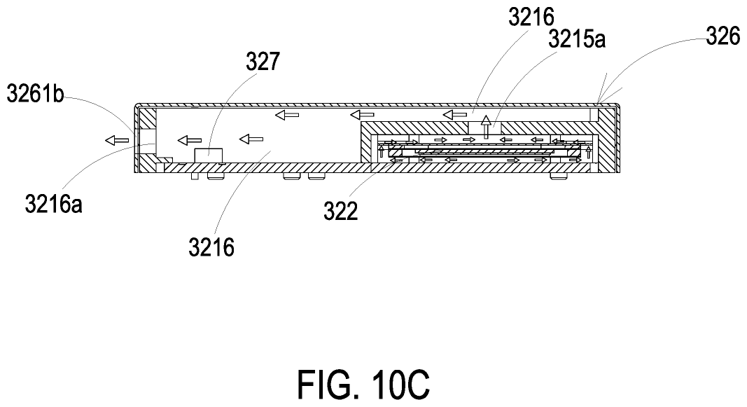

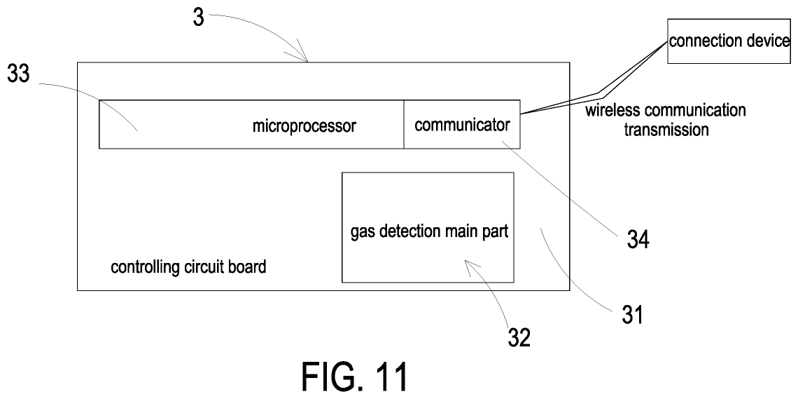

Please refer to FIG. 3 to FIG. 11. In the embodiment, the gas detection device 3 includes a controlling circuit board 31, a gas detection main part 32, a microprocessor 33 and a communicator 34. The gas detection main part 32, the microprocessor 33 and the communicator 34 are integrally packaged on the controlling circuit board 31 and electrically connected to each other. Preferably but not exclusively, the microprocessor 33 and the communicator 34 are disposed on the controlling circuit board 31, and the microprocessor 33 controls the driving signal of the gas detection main part 32 to enable the detection. The gas detection main part 32 detects the air pollution and outputs a detection signal. The microprocessor 33 receives the detection signal for calculating, processing and outputting, so that the microprocessor 33 of the gas detection device 3 generates the air pollution data, which are provided to the communicator 34, and externally transmitted to a connection device through a wireless communication transmission. Preferably but not exclusively, the wireless communication transmission is one selected from the group consisting of a Wi-Fi communication transmission, a Bluetooth communication transmission, a radio frequency identification communication transmission and a near field communication (NFC) transmission.

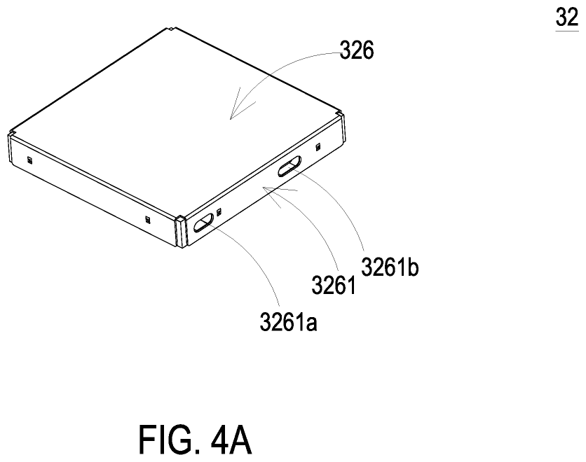

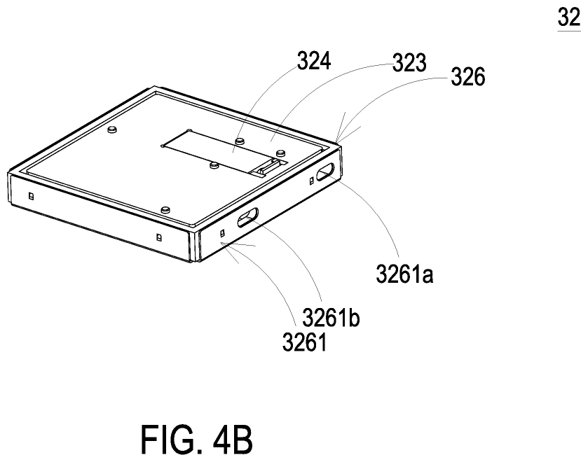

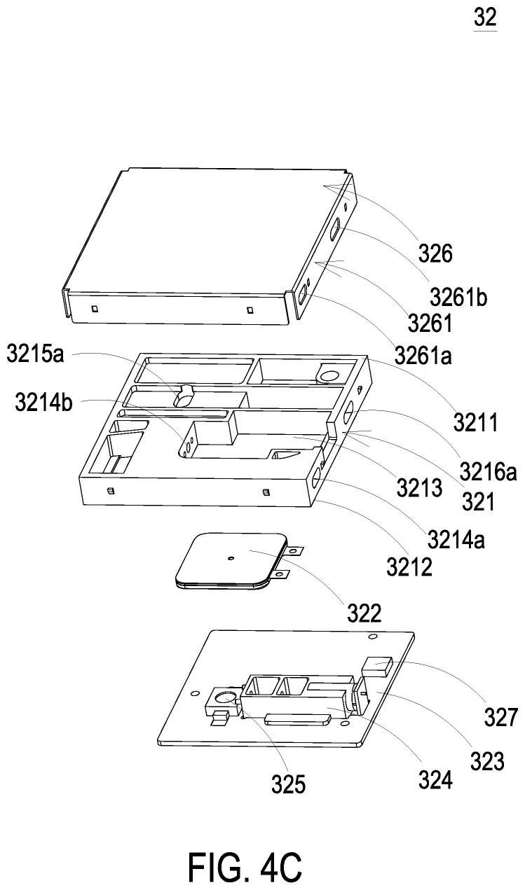

Please refer to FIG. 4A to FIG. 9A. In the embodiment, the gas detection main part 32 includes a base 321, a piezoelectric actuator 322, a driving circuit board 323, a laser component 324, a particulate sensor 325 and an outer cover 326. In the embodiment, the base 321 includes a first surface 3211, a second surface 3212, a laser loading region 3213, a gas-inlet groove 3214, a gas-guiding-component loading region 3215 and a gas-outlet groove 3216. The first surface 3211 and the second surface 3212 are two surfaces opposite to each other. In the embodiment, the laser loading region 3213 for the laser component 324 is hollowed out from the first surface 3211 toward the second surface 3212. The outer cover 326 covers the base 321 and includes a side plate 3261. The side plate 3261 has an inlet opening 3261a and an outlet opening 3261b. The gas-inlet groove 3214 is concavely formed from the second surface 3212 and disposed adjacent to the laser loading region 3213. The gas-inlet groove 3214 includes a gas-inlet 3214a and two lateral walls. The gas-inlet 3214a is in communication with an environment outside the base 321, and is spatially corresponding in position to an inlet opening 3261a of the outer cover 326. Two transparent windows 3214b are opened on the two lateral walls of the gas-inlet groove 3214 and are in communication with the laser loading region 3213. Therefore, the first surface 3211 of the base 321 is covered and attached by the outer cover 326, and the second surface 3212 is covered and attached by the driving circuit board 323, so that an inlet path is defined by the gas-inlet groove 3214.

In the embodiment, the gas-guiding-component loading region 3215 mentioned above is concavely formed from the second surface 3212 and in communication with the gas-inlet groove 3214. A ventilation hole 3215a penetrates a bottom surface of the gas-guiding-component loading region 3215. The gas-guiding-component loading region 3215 includes four positioning protrusions 3215b disposed at four corners of the gas-guiding-component loading region 3215, respectively. In the embodiment, the gas-outlet groove 3216 includes a gas-outlet 3216a, and the gas-outlet 3216a is spatially corresponding to the outlet opening 3261b of the outer cover 326. The gas-outlet groove 3216 includes a first section 3216b and a second section 3216c. The first section 3216b is concavely formed out from the first surface 3211 in a region spatially corresponding to a vertical projection area of the gas-guiding-component loading region 3215. The second section 3216c is hollowed out from the first surface 3211 to the second surface 3212 in a region where the first surface 3211 is extended from the vertical projection area of the gas-guiding-component loading region 3215. The first section 3216b and the second section 3216c are connected to form a stepped structure. Moreover, the first section 3216b of the gas-outlet groove 3216 is in communication with the ventilation hole 3215a of the gas-guiding-component loading region 3215, and the second section 3216c of the gas-outlet groove 3216 is in communication with the gas-outlet 3216a. In that, when first surface 3211 of the base 321 is attached and covered by the outer cover 326 and the second surface 3212 of the base 321 is attached and covered by the driving circuit board 323, the gas-outlet groove 3216 and the driving circuit board 323 collaboratively define an outlet path.

In the embodiment, the laser component 324 and the particulate sensor 325 are disposed on and electrically connected to the driving circuit board 323 and located within the base 321. In order to clearly describe and illustrate the positions of the laser component 324 and the particulate sensor 325 in the base 321, the driving circuit board 323 is intentionally omitted. The laser component 324 is accommodated in the laser loading region 3213 of the base 321, and the particulate sensor 325 is accommodated in the gas-inlet groove 3214 of the base 321 and is aligned to the laser component 324. In addition, the laser component 324 is spatially corresponding to the transparent window 3214b. Therefore, a light beam emitted by the laser component 324 passes through the transparent window 3214b and is irradiated into the gas-inlet groove 3214. A light beam path from the laser component 324 passes through the transparent window 3214b and extends in an orthogonal direction perpendicular to the gas-inlet groove 3214. Preferably but not exclusively, the particulate sensor 325 is used for detecting the suspended particulate information. In the embodiment, a projecting light beam emitted from the laser component 324 passes through the transparent window 3214b and enters the gas-inlet groove 3214 to irradiate the suspended particles contained in the gas passing through the gas-inlet groove 3214. When the suspended particles contained in the gas are irradiated and generate scattered light spots, the scattered light spots are received and calculated by the particulate sensor 325 to obtain the gas detection information. In the embodiment, a gas sensor 327 is positioned and disposed on the driving circuit board 323, electrically connected to the driving circuit board 323, and accommodated in the gas-outlet groove 3216, so as to detect the air pollution introduced into the gas-outlet groove 3216. Preferably but not exclusively, in an embodiment, the gas sensor 327 includes a volatile-organic-compound sensor for detecting the gas information of carbon dioxide (CO₂) or volatile organic compounds (TVOC). Preferably but not exclusively, in an embodiment, the gas sensor 327 includes a formaldehyde sensor for detecting the gas information of formaldehyde (HCHO). Preferably but not exclusively, in an embodiment, the gas sensor 327 includes a bacteria sensor for detecting the gas information of bacteria or fungi. Preferably but not exclusively, in an embodiment, the gas sensor 327 includes a virus sensor for detecting the gas information of virus.

In the embodiment, the piezoelectric actuator 322 is accommodated in the square-shaped gas-guiding-component loading region 3215 of the base 321. In addition, the gas-guiding-component loading region 3215 of the base 321 is in fluid communication with the gas-inlet groove 3214. When the piezoelectric actuator 322 is enabled, the gas in the gas-inlet 3214 is inhaled into the piezoelectric actuator 322, flows through the ventilation hole 3215a of the gas-guiding-component loading region 3215 into the gas-outlet groove 3216. Moreover, the driving circuit board 323 covers the second surface 3212 of the base 321, and the laser component 324 is positioned and disposed on the driving circuit board 323, and is electrically connected to the driving circuit board 323. The particulate sensor 325 is also positioned and disposed on the driving circuit board 323, and is electrically connected to the driving circuit board 323. In that, when the outer cover 326 covers the base 321, the inlet opening 3261a is spatially corresponding to the gas-inlet 3214a of the base 321, and the outlet opening 3261b is spatially corresponding to the gas-outlet 3216a of the base 321.

In the embodiment, the piezoelectric actuator 322 includes a gas-injection plate 3221, a chamber frame 3222, an actuator element 3223, an insulation frame 3224 and a conductive frame 3225. In the embodiment, the gas-injection plate 3221 is made by a flexible material and includes a suspension plate 3221a and a hollow aperture 3221b. The suspension plate 3221a is a sheet structure and is permitted to undergo a bending deformation. Preferably but not exclusively, the shape and the size of the suspension plate 3221a are accommodated in the inner edge of the gas-guiding-component loading region 3215, but not limited thereto. The hollow aperture 3221b passes through a center of the suspension plate 3221a, so as to allow the gas to flow therethrough. Preferably but not exclusively, in the embodiment, the shape of the suspension plate 3221a is selected from the group consisting of a square, a circle, an ellipse, a triangle and a polygon, but not limited thereto.

In the embodiment, the chamber frame 3222 is carried and stacked on the gas-injection plate 3221. In addition, the shape of the chamber frame 3222 is corresponding to the gas-injection plate 3221. The actuator element 3223 is carried and stacked on the chamber frame 3222. A resonance chamber 3226 is collaboratively defined by the actuator element 3223, the chamber frame 3222 and the suspension plate 3221a and is formed between the actuator element 3223, the chamber frame 3222 and the suspension plate 3221a. The insulation frame 3224 is carried and stacked on the actuator element 3223 and the appearance of the insulation frame 3224 is similar to that of the chamber frame 3222. The conductive frame 3225 is carried and stacked on the insulation frame 3224, and the appearance of the conductive frame 3225 is similar to that of the insulation frame 3224. In addition, the conductive frame 3225 includes a conducting pin 3225a and a conducting electrode 3225b. The conducting pin 3225a is extended outwardly from an outer edge of the conductive frame 3225, and the conducting electrode 3225b is extended inwardly from an inner edge of the conductive frame 3225. Moreover, the actuator element 3223 further includes a piezoelectric carrying plate 3223a, an adjusting resonance plate 3223b and a piezoelectric plate 3223c. The piezoelectric carrying plate 3223a is carried and stacked on the chamber frame 3222. The adjusting resonance plate 3223b is carried and stacked on the piezoelectric carrying plate 3223a. The piezoelectric plate 3223c is carried and stacked on the adjusting resonance plate 3223b. The adjusting resonance plate 3223b and the piezoelectric plate 3223c are accommodated in the insulation frame 3224. The conducting electrode 3225b of the conductive frame 3225 is electrically connected to the piezoelectric plate 3223c. In the embodiment, the piezoelectric carrying plate 3223a and the adjusting resonance plate 3223b are made by a conductive material. The piezoelectric carrying plate 3223a includes a piezoelectric pin 3223d. The piezoelectric pin 3223d and the conducting pin 3225a are electrically connected to a driving circuit (not shown) of the driving circuit board 323, so as to receive a driving signal, such as a driving frequency and a driving voltage. Through this structure, a circuit is formed by the piezoelectric pin 3223d, the piezoelectric carrying plate 3223a, the adjusting resonance plate 3223b, the piezoelectric plate 3223c, the conducting electrode 3225b, the conductive frame 3225 and the conducting pin 3225a for transmitting the driving signal. Moreover, the insulation frame 3224 is insulated between the conductive frame 3225 and the actuator element 3223, so as to avoid the occurrence of a short circuit. Thereby, the driving signal is transmitted to the piezoelectric plate 3223c. After receiving the driving signal such as the driving frequency and the driving voltage, the piezoelectric plate 3223c deforms due to the piezoelectric effect, and the piezoelectric carrying plate 3223a and the adjusting resonance plate 3223b are further driven to generate the bending deformation in the reciprocating manner.

Furthermore, in the embodiment, the adjusting resonance plate 3223b is located between the piezoelectric plate 3223c and the piezoelectric carrying plate 3223a and served as a cushion between the piezoelectric plate 3223c and the piezoelectric carrying plate 3223a. Thereby, the vibration frequency of the piezoelectric carrying plate 3223a is adjustable. Basically, the thickness of the adjusting resonance plate 3223b is greater than the thickness of the piezoelectric carrying plate 3223a, and the vibration frequency of the actuator element 3223 can be adjusted by adjusting the thickness of the adjusting resonance plate 3223b.

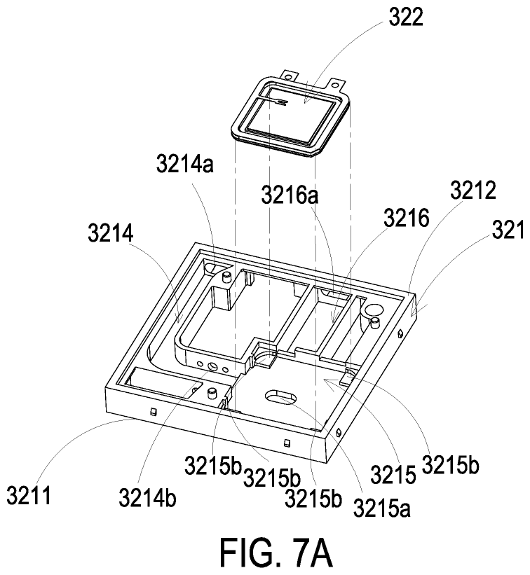

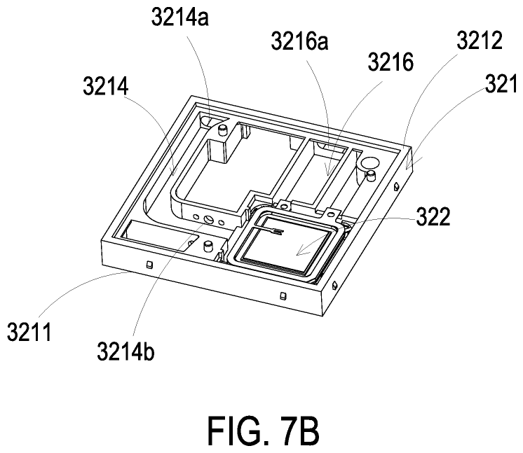

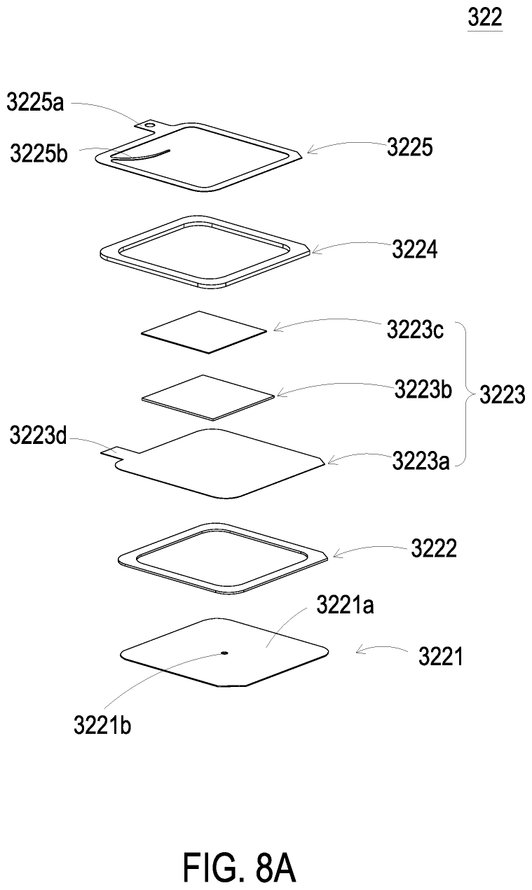

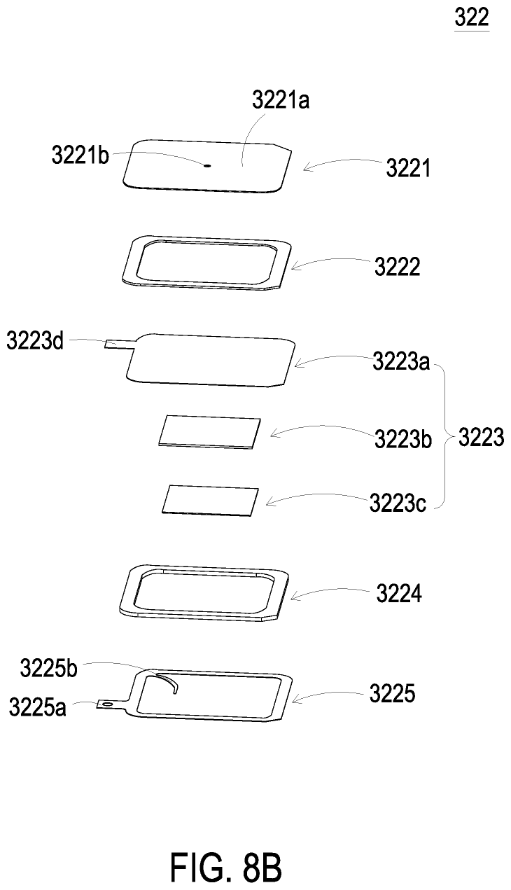

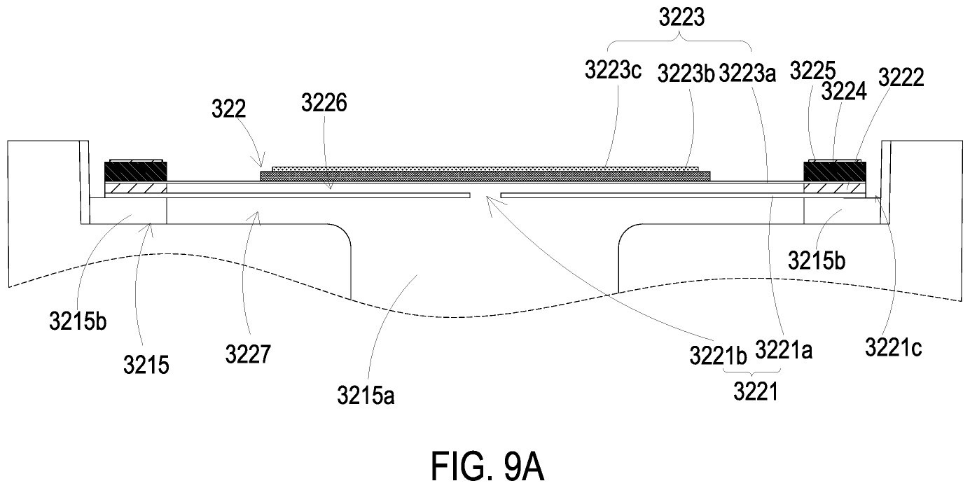

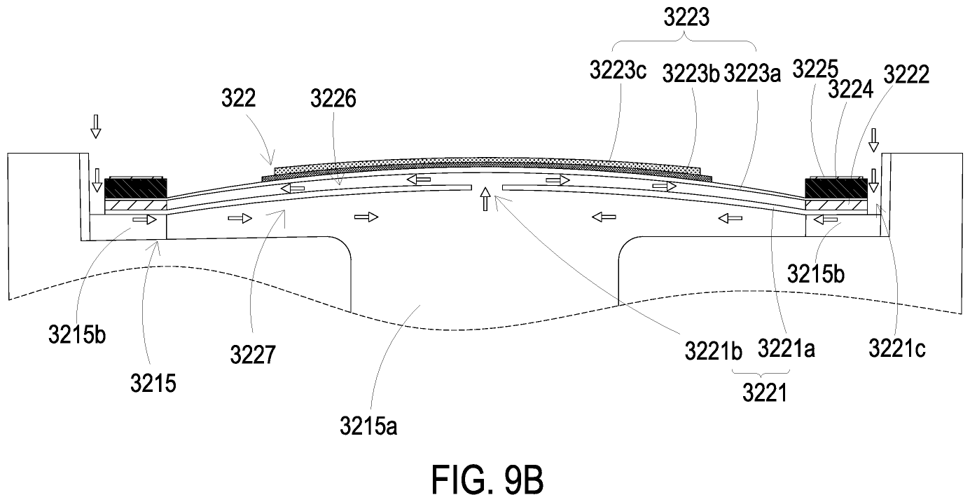

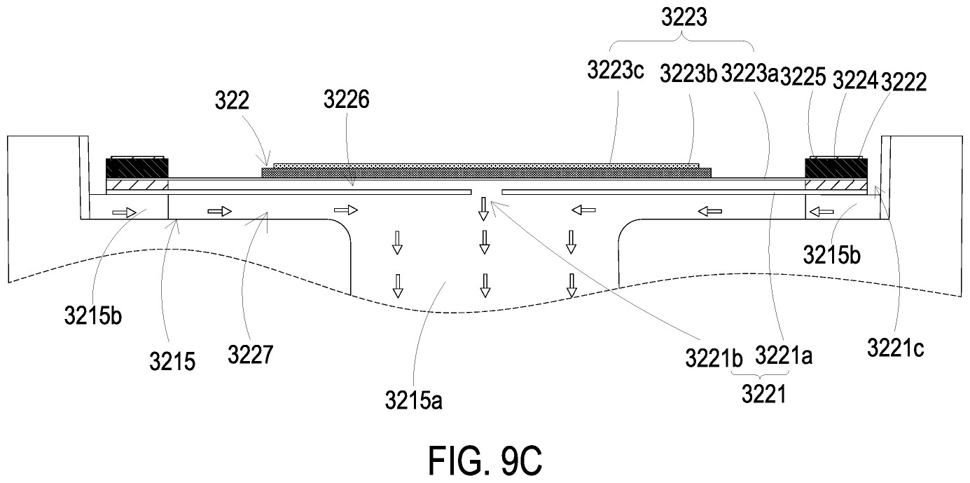

Please refer to FIG. 7A, FIG. 7B, FIG. 8A, FIG. 8B and FIG. 9A. In the embodiment, the gas-injection plate 3221, the chamber frame 3222, the actuator element 3223, the insulation frame 3224 and the conductive frame 3225 are stacked and positioned in the gas-guiding-component loading region 3215 sequentially, so that the piezoelectric actuator 322 is supported and positioned in the gas-guiding-component loading region 3215. A plurality of clearances 3221c are defined between the suspension plate 3221a of the gas-injection plate 3221 and an inner edge of the gas-guiding-component loading region 3215 for gas flowing therethrough. In the embodiment, a flowing chamber 3227 is formed between the gas-injection plate 3221 and the bottom surface of the gas-guiding-component loading region 3215. The flowing chamber 3227 is in communication with the resonance chamber 3226 between the actuator element 3223, the chamber frame 3222 and the suspension plate 3221a through the hollow aperture 3221b of the gas-injection plate 3221. By controlling the vibration frequency of the gas in the resonance chamber 3226 to be close to the vibration frequency of the suspension plate 3221a, the Helmholtz resonance effect is generated between the resonance chamber 3226 and the suspension plate 3221a, so as to improve the efficiency of gas transportation. When the piezoelectric plate 3223c is moved away from the bottom surface of the gas-guiding-component loading region 3215, the suspension plate 3221a of the gas-injection plate 3221 is driven to move away from the bottom surface of the gas-guiding-component loading region 3215 by the piezoelectric plate 3223c. In that, the volume of the flowing chamber 3227 is expanded rapidly, the internal pressure of the flowing chamber 3227 is decreased to form a negative pressure, and the gas outside the piezoelectric actuator 322 is inhaled through the clearances 3221c and enters the resonance chamber 3226 through the hollow aperture 3221b. Consequently, the pressure in the resonance chamber 3226 is increased to generate a pressure gradient. When the suspension plate 3221a of the gas-injection plate 3221 is driven by the piezoelectric plate 3223c to move toward the bottom surface of the gas-guiding-component loading region 3215, the gas in the resonance chamber 3226 is discharged out rapidly through the hollow aperture 3221b, and the gas in the flowing chamber 3227 is compressed, thereby the converged gas is quickly and massively ejected out of the flowing chamber 3227 under the condition close to an ideal gas state of the Benulli's law, and transported to the ventilation hole 3215a of the gas-guiding-component loading region 3215.

By repeating the above operation steps shown in FIG. 9B and FIG. 9C, the piezoelectric plate 3223c is driven to generate the bending deformation in a reciprocating manner. According to the principle of inertia, since the gas pressure inside the resonance chamber 3226 is lower than the equilibrium gas pressure after the converged gas is ejected out, the gas is introduced into the resonance chamber 3226 again. Moreover, the vibration frequency of the gas in the resonance chamber 3226 is controlled to be close to the vibration frequency of the piezoelectric plate 3223c, so as to generate the Helmholtz resonance effect to achieve the gas transportation at high speed and in large quantities. The gas is inhaled through the inlet opening 3261a of the outer cover 326, flows into the gas-inlet groove 3214 of the base 321 through the gas-inlet 3214a, and is transported to the position of the particulate sensor 325. The piezoelectric actuator 322 is enabled continuously to inhale the gas into the inlet path, and facilitate the gas outside the gas detection device to be introduced rapidly, flow stably, and transported above the particulate sensor 325. At this time, a projecting light beam emitted from the laser component 324 passes through the transparent window 3214b to irritate the suspended particles contained in the gas flowing above the particulate sensor 325 in the gas-inlet groove 3214. When the suspended particles contained in the gas are irradiated and generate scattered light spots, the scattered light spots are received and calculated by the particulate sensor 325 for obtaining related information about the sizes and the concentration of the suspended particles contained in the gas. Moreover, the gas above the particulate sensor 325 is continuously driven and transported by the piezoelectric actuator 322, flows into the ventilation hole 3215a of the gas-guiding-component loading region 3215, and is transported to the gas-outlet groove 3216. At last, after the gas flows into the gas outlet groove 3216, the gas is continuously transported into the gas-outlet groove 3216 by the piezoelectric actuator 322, and thus the gas in the gas-outlet groove 3216 is pushed to discharge through the gas-outlet 3216a and the outlet opening 3261b.

In the present disclosure, the gas detection device A of the central controller B can not only detect the suspended particles in the gas, but also further detect the characteristics of the imported gas, such as formaldehyde, ammonia, carbon monoxide, carbon dioxide, oxygen and ozone. Therefore, the gas detection device A of the central controller B of the present disclosure further includes a gas sensor 327. Preferably but not exclusively, the gas sensor 327 is positioned and electrically connected to the driving circuit board 323, and is accommodated in the gas outlet groove 3216. Whereby, the concentration or the characteristics of volatile organic compounds contained in the gas drained out through the outlet path.

In summary, the present disclosure provides a central controller for completely cleaning indoor air pollution. With the central controller disposed in an indoor space, the central controller detects air pollution in the indoor space and generates air pollution data, and process the air pollution data using the wireless communication. Then, the characteristic, the concentration and the location of the air pollution in the indoor space are intelligently determined, and the fan is intelligently driven to generate a directional air convection. Through the physical or chemical filtration elements, the air pollution in the indoor space is removed, so as to completely clean the indoor air pollution to form a clean and safe breathing air state in the indoor space. The present disclosure includes the industrial applicability and the inventive steps.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A central controller for completely cleaning indoor air pollution, wherein the central controller is disposed in an indoor space to detect air pollution and output air pollution data, wherein intelligence operations are implemented in accordance with the air pollution data by the central controller to determine a location of the air pollution, and a controlling instruction is intelligently and selectively issued through a wireless communication transmission to enable a plurality of physical filtration devices or a plurality of chemical filtration devices, wherein each of the physical filtration devices or the chemical filtration devices comprises at least one fan and at least one filter element, wherein the fan is driven upon receiving the controlling instruction, so as to generate an airflow convection in a direction, wherein the air pollution is removed through the filter element, so that the air pollution in the indoor space is completely cleaned to form a clean and safe breathing air state.

2. The central controller for completely cleaning indoor air pollution according to claim 1, wherein the air pollution is at least one selected from the group consisting of suspended particulate matter, carbon monoxide, carbon dioxide, ozone, sulfur dioxide, nitrogen dioxide, lead, total volatile organic compounds (TVOC), formaldehyde, bacteria, fungi, virus and a combination thereof.

3. The central controller for completely cleaning indoor air pollution according to claim 1, wherein the central controller comprises a central processing unit, a communication interface and a gas detection device, wherein the gas detection device detects the air pollution, provides the air pollution data and outputs the air pollution data to the central processing unit, wherein the central processing unit implements the intelligence operations in accordance with the air pollution data to determine the location of the air pollution, and intelligently and selectively issues the controlling instruction through the communication interface to the plurality of the physical filtration device or the chemical filtration device.

4. The central controller for completely cleaning indoor air pollution according to claim 3, wherein the communication interface is connected through a wireless communication transmission, and the wireless communication transmission is one selected from the group consisting of a Wi-Fi communication transmission, a Bluetooth communication transmission, a radio frequency identification communication transmission and a near field communication (NFC) transmission.

5. The central controller for completely cleaning indoor air pollution according to claim 3, wherein the communication interface is connected through a wired communication transmission.

6. The central controller for completely cleaning indoor air pollution according to claim 3, wherein the central processing unit implements the intelligence operations through a connection of a cloud device, so that artificial intelligence operations and big data comparison are implemented through the cloud device to determine the location of the air pollution in the indoor space, wherein the controlling instruction is intelligently and selectively issued through the communication interface to the plurality of the physical filtration device or the plurality of chemical filtration device.

7. The central controller for completely cleaning indoor air pollution according to claim 3 wherein the central processing unit intelligently and selectively issues the controlling instruction through the communication interface to enable a part of the plurality of physical filtration devices or the plurality of chemical filtration devices adjacent to the location of the air pollution first, and then intelligently and selectively issues the controlling instruction through the communication interface to enable the rest of the plurality of physical filtration devices or the plurality of chemical filtration devices, so as to generate the airflow convection, whereby the flow of the air pollution is accelerated to drain through the airflow convection toward the plurality of physical filtration device or the plurality of chemical filtration devices adjacent to the location of the air pollution for filtering and cleaning the air pollution.

8. The central controller for completely cleaning indoor air pollution according to claim 1, wherein the filter element of the physical filtration device is a blocking and absorbing filter screen to form a physical removal device.

9. The central controller for completely cleaning indoor air pollution according to claim 8, wherein the filter screen is a high efficiency particulate air (HEPA) filter screen.

10. The central controller for completely cleaning indoor air pollution according to claim 1, wherein the filter element of the chemical filtration device is coated with a decomposition layer to form a chemical removal device.

11. The central controller for completely cleaning indoor air pollution according to claim 10, wherein the decomposition layer is one selected from the group consisting of an activated carbon, a cleansing factor containing chlorine dioxide layer and a combination thereof.

12. The central controller for completely cleaning indoor air pollution according to claim 10, wherein the decomposition layer is an herbal protective layer extracted from ginkgo and Japanese Rhus chinensis to form an herbal protective anti-allergic filter.

13. The central controller for cleaning indoor air pollution according to claim 10 wherein the decomposition layer is one selected from the group consisting of a sliver ion, a zeolite and a combination thereof.

14. The central controller for completely cleaning indoor air pollution according to claim 1, wherein the filter element of the chemical filtration device is combined with a light irradiation element to form a chemical removal device.

15. The central controller for completely cleaning indoor air pollution according to claim 14, wherein the light irradiation element is a photo-catalyst unit comprising a photo catalyst and an ultraviolet lamp.

16. The central controller for completely cleaning indoor air pollution according to claim 14, wherein the light irradiation element is a photo-plasma unit comprising a nanometer irradiation tube.

17. The central controller for completely cleaning indoor air pollution according to claim 1, wherein the filter element of the chemical filtration device is combined with a decomposition unit to form a chemical removal device.

18. The central controller for completely cleaning indoor air pollution according to claim 17, wherein the decomposition unit is one selected from the group consisting of a negative ion unit, a plasma ion unit and a combination thereof.

19. The central controller for completely cleaning indoor air pollution according to claim 3, wherein the gas detection device comprises a controlling circuit board, a gas detection main part, a microprocessor and a communicator, and the gas detection main part, the microprocessor and the communicator are integrally packaged on the controlling circuit board and electrically connected to the controlling circuit board, wherein the microprocessor controls the detection of the gas detection main part, the gas detection main part detects the air pollution and outputs a detection signal, and the microprocessor receives and processes the detection signal to generate air pollution data and provides the air pollution data to the communicator for a wireless communication transmission externally.

20. The central controller for completely cleaning indoor air pollution according to claim 19, wherein the gas detection main part comprises:
a base comprising:
a first surface;
a second surface opposite to the first surface;
a laser loading region hollowed out from the first surface to the second surface;
a gas-inlet groove concavely formed from the second surface and disposed adjacent to the laser loading region, wherein the gas-inlet groove comprises a gas-inlet and two lateral walls, the gas-inlet is in communication with an environment outside the base, and a transparent window is opened on the two lateral walls and is in communication with the laser loading region;
a gas-guiding-component loading region concavely formed from the second surface and in communication with the gas-inlet groove, wherein a ventilation hole penetrates a bottom surface of the gas-guiding-component loading region; and
a gas-outlet groove concavely formed from the first surface, spatially corresponding to the bottom surface of the gas-guiding-component loading region, and hollowed out from the first surface to the second surface in a region where the first surface is not aligned with the gas-guiding-component loading region, wherein the gas-outlet groove is in communication with the ventilation hole, and a gas-outlet is disposed in the gas-outlet groove;
a piezoelectric actuator accommodated in the gas-guiding-component loading region;
a driving circuit board covering and attached to the second surface of the base;
a laser component positioned and disposed on the driving circuit board, electrically connected to the driving circuit board, and accommodated in the laser loading region, wherein a light beam path emitted from the laser component passes through the transparent window and extends in a direction perpendicular to the gas-inlet groove, thereby forming an orthogonal direction with the gas-inlet groove;
a particulate sensor positioned and disposed on the driving circuit board, electrically connected to the driving circuit board, and disposed at an orthogonal position where the gas-inlet groove intersects the light beam path of the laser component in the orthogonal direction, so that suspended particles of the air pollution source passing through the gas-inlet groove and irradiated by a projecting light beam emitted from the laser component are detected;
a gas sensor positioned and disposed on the driving circuit board, electrically connected to the driving circuit board, and accommodated in the gas-outlet groove, so as to detect the air pollution source introduced into the gas-outlet groove; and
an outer cover covering the base and comprising a side plate, wherein the side plate has an inlet opening and an outlet opening, the inlet opening is spatially corresponding to the gas-inlet of the base, and the outlet opening is spatially corresponding to the gas-outlet of the base;
wherein the outer cover covers the base, and the driving circuit board covers the second surface, thereby an inlet path is defined by the gas-inlet groove, and an outlet path is defined by the gas-outlet groove, so that the air pollution source is inhaled from the environment outside the base by the piezoelectric actuator, transported into the inlet path defined by the gas-inlet groove through the inlet opening, and passes through the particulate sensor to detect the particle concentration of the suspended particles contained in the air pollution source, and the air pollution source transported through the piezoelectric actuator is transported out of the outlet path defined by the gas-outlet groove through the ventilation hole, passes through the gas sensor for detecting, and then discharged through the outlet opening.

21. The central controller for completely cleaning indoor air pollution according to claim 20, wherein the particulate sensor is used for detecting the suspended particulate information.

22. The central controller for completely cleaning indoor air pollution according to claim 20, wherein the gas sensor comprises a volatile-organic-compound sensor for detecting the gas information of carbon dioxide or total volatile organic compounds.

23. The central controller for completely cleaning indoor air pollution according to claim 20, wherein the gas sensor comprises one selected from the group consisting of a formaldehyde sensor, a bacteria sensor and a combination thereof, wherein the formaldehyde sensor detects the gas information of formaldehyde, and the bacteria sensor detects the gas information of bacteria or fungi.

24. The central controller for completely cleaning indoor air pollution according to claim 20, wherein the gas sensor comprises a virus sensor for detecting the gas information of virus.
